(19) United States
(12) Patent Application Publication
(10) Pub. No.: US 2024/0157492 A1
(43) Pub. Date: May 16, 2024

(54) HOLDING DEVICE FOR A CYLINDRICAL BLANK

(71) Applicant: Ivoclar Vivadent AG, Schaan (LI)

(72) Inventor: Patrick Meier, Ludesch (AT)

(21) Appl. No.: 18/510,006

(22) Filed: Nov. 15, 2023

(30) Foreign Application Priority Data
Nov. 16, 2022 (DE) 102022130343.8

(51) Int. Cl. B23Q 3/06; A61C 13/00

(52) U.S. Cl. CPC B23Q 3/062; A61C 13/0022; B23Q 3/061

(57) ABSTRACT

A holding device (100) for a cylindrical blank (200), including a cylindrical recess (103) for inserting the blank (200); and a straight slot (105) intersecting the cylindrical recess (103) beyond the central point.

### CROSS-REFERENCE TO RELATED APPLICATIONS

This application claims priority to DE 10 2022 130 343.8 filed on Nov. 16, 2022, the disclosure of which is incorporated herein by reference in its entirety.

### TECHNICAL FIELD

The present invention relates to a holding device for a cylindrical blank, a ring holder for receiving the holding device and a method of producing an abutment.

### BACKGROUND

Until now, when clamping blanks for the production of abutments in a holder, large displacements of the interface of the blank occur in relation to the reference system of a dental milling machine. The deformations are primarily caused by the pre-tensioning forces of the screws, which position the blank firmly in the holding device so that the blank is not pulled out of the holder during the milling process.

Therefore, the blanks for producing abutments are measured at their interface to ensure the accuracy of the produced abutments. The precision of the machined blanks is composed of manufacturing tolerances of the individual components in the tolerance chain of the dental milling machine, the machining accuracy of the dental milling machine itself and the deformations of the holder, which change the position of the blank in space. However, this requires a measuring system in the milling machine, which is not available in many dental milling machines. In addition, the overall process takes longer due to the measurement.

U.S. Pat. Nos. 11,426,263, 10,010,386, 10,213,841 and 20090274994 which are hereby incorporated by reference, relate to holding devices for a dental workpiece or blank.

### SUMMARY

It is the technical aim of the invention to be able to machine such blanks in milling machines without a measuring system and to reduce a machining time.

This technical task is solved by subject matter according to the independent claims. Technically advantageous embodiments are the subject matter of the dependent claims, the description and the drawings.

According to a first aspect, the technical task is solved by a holding device for a cylindrical blank, comprising a cylindrical recess for inserting the blank; and a straight slot intersecting the cylindrical recess beyond the central point. This holding device allows sufficient accuracy of the produced abutment without prior calibration. The shaping of the holding device and integration into the overall system of the milling machine is configured such that maximum rigidity and position-independent clamping is possible without prior calibration of the blank.

In a technically advantageous embodiment of the holding device, the slot forms a movable clamping jaw for clamping the cylindrical blank to a fixed part of the holding device. This provides the technical advantage, for example, that the fixed part can be made as high and rigid as possible. This in turn results in low deformations when clamping the blank.

In another technically advantageous embodiment of the holding device, the cylindrical recess comprises a closed bottom surface covering the bottom of the fixed part. This provides the technical advantage, for example, of improving the rigidity of the holding device.

In another technically advantageous embodiment of the holding device, the bottom surface extends only on one side of the slot. This provides the technical advantage, for example, of achieving good rigidity of the holding device.

In another technically advantageous embodiment of the holding device, the slot runs partially parallel to a lower edge of the holding device. This provides the technical advantage, for example, of improving the strength of the holding device.

In another technically advantageous embodiment of the holding device, the holding device comprises a screw for clamping the blank. The screw can be arranged symmetrically in the clamping jaw. This provides the technical advantage, for example, of achieving a high clamping effect.

In another technically advantageous embodiment of the holding device, the holding device comprises a positioning ridge which runs in the axial direction of the recess. This provides the technical advantage, for example, of improving the rigidity of the holding device.

In another technically advantageous embodiment of the holding device, the positioning ridge is formed by two grooves which run in the axial direction in the cylindrical recess. This provides the technical advantage, for example, that the axial positioning ridge can be produced in a simple manner.

In another technically advantageous embodiment of the holding device, the holding device comprises several cylindrical recesses for inserting blanks. This provides the technical advantage, for example, that several abutments with low manufacturing tolerance can be produced in one machining step within the dental milling machine.

In another technically advantageous embodiment of the holding device, the bottom sides of two respective cylindrical recesses are arranged opposite each other. This provides the technical advantage, for example, that the holding device has a high degree of rigidity even when several blanks are used.

In another technically advantageous embodiment of the holding device, the holding device is bar-shaped, block-shaped or rod-shaped. This does not restrict accessibility in the dental milling machine. This provides the technical advantage, for example, that the block-shaped bar of the holding device has a high rigidity.

In another technically advantageous embodiment of the holding device, the holding device comprises a mechanical interface for fastening and positioning in a ring holder. This provides the technical advantage, for example, that the holding device can be used in a simple manner in a dental milling machine.

In another technically advantageous embodiment of the holding device, the mechanical interface comprises a bore for receiving a fastening screw. This provides the technical advantage, for example, that the holding device can be fastened in the ring holder in a stable and simple manner.

According to a second aspect, the technical task is solved by a ring holder for receiving a holding device according to the first aspect. The ring holder may comprise the holding device. The ring holder and the holding device may also form a unit. The ring holder comprising the holding device provides the same technical advantages as the holding device according to the first aspect.

According to a third aspect, the technical task is solved by a method of producing an abutment, comprising the steps of inserting a blank into a holding device according to the first aspect and producing the abutment without prior calibration of the blank or the interface arranged on the blank. The interface is later inserted into an implant and serves to connect the abutment produced from the blank to the implant.

The method provides the same technical advantages as the holding device according to the first aspect. In addition, the technical advantage is achieved that the interface is not touched or damaged by a milling tool.

### BRIEF DESCRIPTION OF THE DRAWINGS

Exemplary embodiments of the invention are shown in the drawings and are described in more detail below, in which:

FIG. 1 shows a perspective view of a holding device for a cylindrical blank;

FIG. 2 shows a perspective view of a holding device with an inserted cylindrical blank;

FIG. 3 shows a top view of the holding device with the inserted cylindrical blank;

FIG. 4 shows a side view of the holding device; and

FIG. 5 shows a perspective view of a ring holder with the inserted holding device.

### DETAILED DESCRIPTION

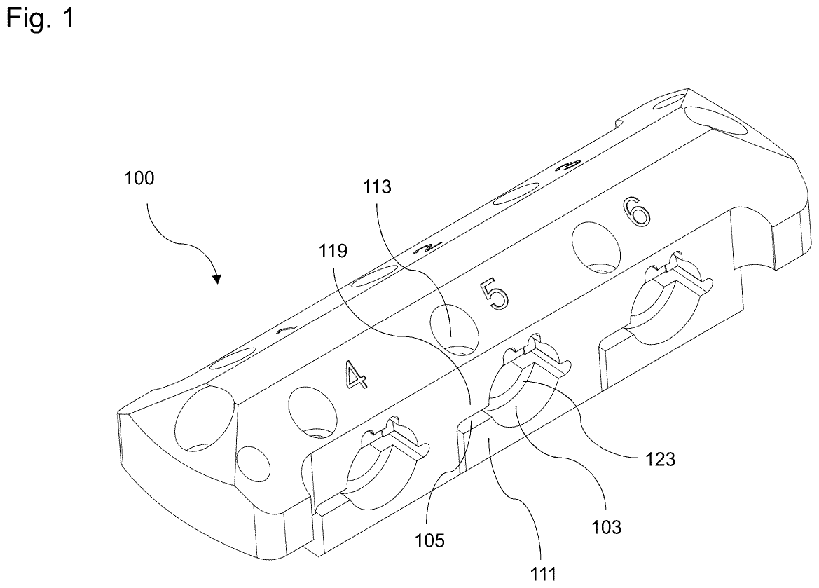

FIG. 1 shows a perspective view of a holding device 100 for cylindrical dental blanks (so-called preforms) from which abutments are produced. The holding device 100 is used to hold the blanks 200 in a milling machine. The block- or bar-shaped holding device 100 comprises several cylindrical recesses 103 for inserting the blanks. In the embodiment shown, there are a total of six cylindrical recesses 103 for inserting the blanks. The block-shaped holding device 100 is widened towards the center in the shape of a roof. This further increases the strength and rigidity of the holding device 100.

In each recess 103 a straight slot 105 is arranged which intersects the cylindrical recess 103 in a secant shape beyond the central point. The centerline of the slot 105 runs beyond the central point of the recess 103. The slot 105 runs parallel to the central axis of the cylindrical recess 103. Thus, the surface formed by the straight slot 105 and the central axis of the cylindrical recess 103 do not intersect.

This increases the clamping area within the recess 103 on one side. The slot 105 is produced by an eccentric pitch milling, creating a fixed part 119 of the holding device 100 and a clamping jaw 111 as a movable part of the holding device 100. However, the clamping jaw 111 also comprises a circular segment-shaped stop 123 for the blank 200. The cylindrical blank 200 is clamped in the recess 103 by the clamping jaw 111 by means of a screw 113.

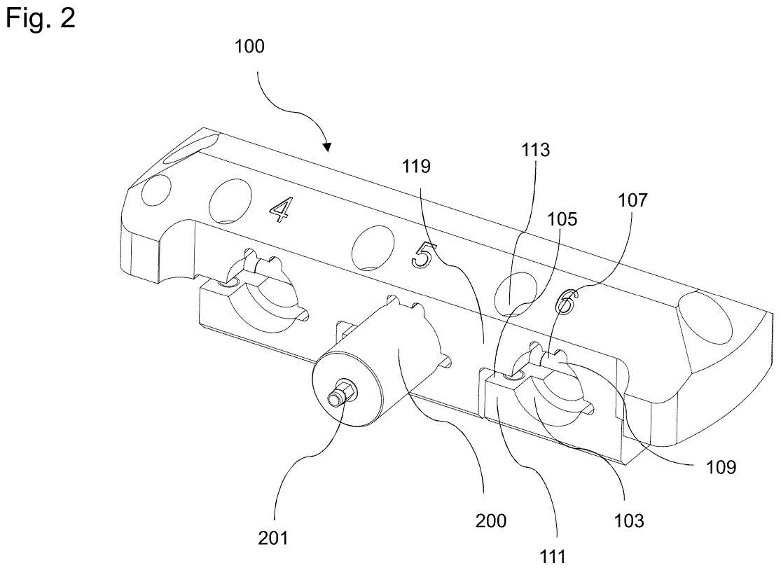

FIG. 2 shows a perspective view of a holding device 100 with an inserted cylindrical blank 200. The blank 200 has a basic cylindrical shape from which the shape of the abutment is milled using a milling tool. The interface 201 of the abutment to an implant is already prefabricated in the blank 200. The blank 200 is an industrially prefabricated blank, preferably made of titanium, cobalt-chrome or ceramic, which is customized within a dental milling machine.

The cylindrical recess 103 comprises a closed bottom surface 107 that covers the bottom 109 of the fixed part 119. When the blank is inserted into the recess 103, the blank 200 abuts the stepped stop 123 of the bottom surface 107, which is arranged on the bottom side of the recess 103. The bore for the cylindrical recess 103 is not continuous in the axial direction of the blank 200 on the fixed side 119 of the holding device 100. The partially closed bottom further improves the stability of the holding device 100. The shaping of the holding device 100 is such that deformations during clamping of the blank 200 are minimal.

Until now, the blanks 200 were measured at their interface to the implant to ensure the accuracy of fit of the produced abutments. This requires a measuring system in the milling machine, which is not available in many dental milling machines. In addition, the overall process takes longer due to the measurement. The holding device 100 for the blank 200 can eliminate the measuring system and calibration and reduce the process time for machining the blank 200.

Due to the stiffer shaping of the holding device 100, it is now possible to machine the blank 200 in the dental milling machine without first measuring the interface. This makes it possible to machine the blank 200 even on a dental milling machine that does not have a measuring device for calibration. It also simplifies and shortens the production process at the dental technician. By minimizing the deformations during clamping, it is possible to keep the overall accuracy of the produced abutments within the required tolerance without the need for calibration.

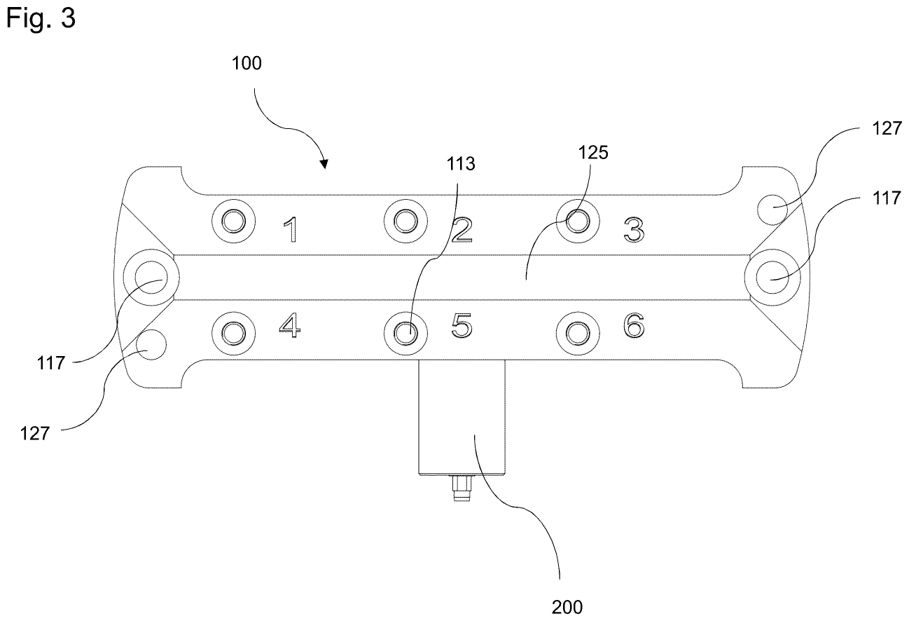

FIG. 3 shows a top view of the holding device 100 with the inserted cylindrical blank 200. The holder has a bore 117 at each of its two ends. A fastening screw is inserted into this bore to connect the holding device 100 to a surrounding ring holder. Towards the center 125, the thickness of the holding device 100 increases to increase the stability and strength of the holding device 100. The two additional bores 127 to the side of the bores 117 are used to position the holding device 100 with two register pins. The holding device 100 can be positioned in a ring holder through these bores 127.

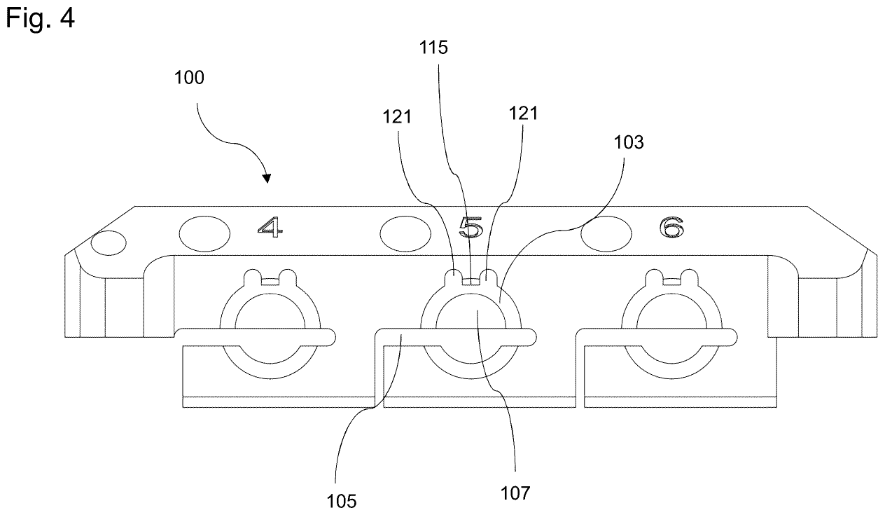

FIG. 4 shows a side view of the holding device 100. A positioning ridge 115 is formed in the cylindrical recess 105, which runs in the axial direction of the recess 103. The positioning ridge 115 is formed by two parallel grooves 121, which also run in the axial direction in the cylindrical recess 103. The positioning ridge 115 allows the blank 200 with a corresponding groove to be inserted in a manner that prevents it from rotating.

This is achieved by widening the overall width of the holding device 100 and increasing the overall height of the holding device 100. For example, the total width of the holding device 100 is 22 mm in the center of the ridge, 29.5 mm at the outer, wider part of the ridge, and the overall height of the holding device 100 is, for example, 23 mm.

The screw size of the holding device 100 is reduced. For the holding device 100, for example, screws 113 of size M3 can be used, which are screwed into a corresponding thread.

Milling free the axial positioning ridge 115 for the blank 200 is performed from the front, i.e. in the axial direction of the recess 103, instead of from above. This results in a stiffening or robustness of the holding device 100. Better positioning is also achieved by widening the ridge in the bearing point of the clamping jaw 111. In addition, a symmetrical alignment of the screws in the holding device 100 and in the clamping jaw is achieved.

The holding device 100 enables sufficient accuracy of the produced abutment. The shaping of the holding device 100 and integration into the overall system of the milling machine is configured to enable maximum rigidity and position-independent clamping without prior calibration of the blank 200.

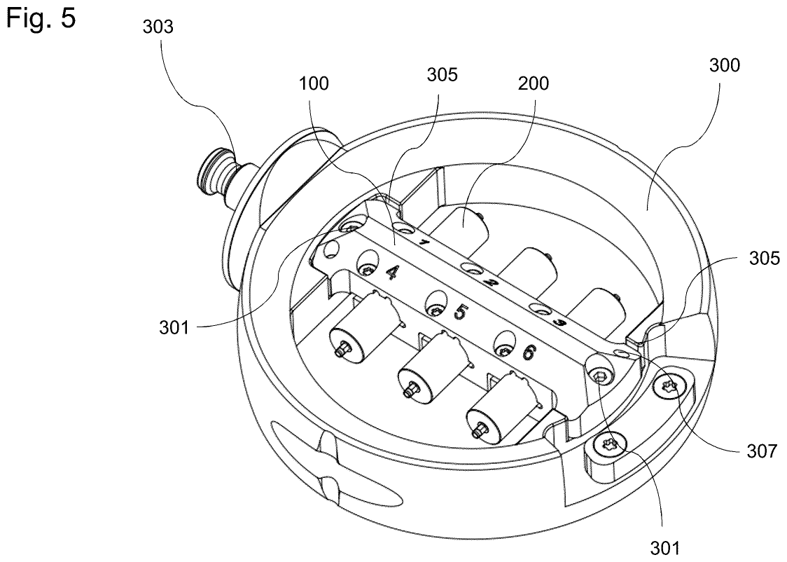

FIG. 5 shows a perspective view of a ring holder 300 with inserted holding device 100. The ring holder 300 serves as a receptacle for the holding device 100 in the dental milling machine. The ring holder 300 comprises two recesses 305 for inserting the lateral ends of the holding device 100.

The holding device 100 is integrated into the ring holder 300 with a standardized interface for clamping in a dental milling machine. The bolt 303 forms the mechanical interface to the dental milling machine.

Every end of the bar-shaped holding device 100 is fastened to the ring holder 300 in each case, so that the holding device 100 extends diametrically through the ring holder 300. The holding device 100 is fastened to the ring holder 300 by means of fastening screws 301. The holding device 100 is positioned in the ring holder 300 by means of protruding register pins 307, which are inserted into the bores 127 of the holding device 100.

The shaping of the holding device 100 in the ring holder 300 allows deformation to be eliminated as a factor influencing the overall tolerance of the produced abutments, or to be reduced such that calibration is not required. The production device 100 is technically advantageous in the context of simplifying the production process and expanding the milling machines that can be used for production without a calibration function.

All of the features explained and shown in connection with individual embodiments of the invention may be provided in different combinations in the subject matter of the invention to simultaneously realize their beneficial effects.

All method steps can be implemented by devices which are suitable for executing the respective method step. All functions that are executed by the features of the subject matter can be a method step of a method.

The scope of protection of the present invention is given by the claims and is not limited by the features explained in the description or shown in the figures.

### REFERENCE LIST

100 holding device
103 recess
105 slot
107 bottom surface
109 bottom
111 clamping jaw
113 screw
115 positioning ridge
117 bore
119 fixed part
121 groove
123 stop
125 center
127 opening
200 blank
201 interface
300 ring holder
301 fastening screw
303 bolt
305 recess
307 register pin

1. A holding device for a cylindrical blank, comprising:
a cylindrical recess for inserting the blank; and
a straight slot intersecting the cylindrical recess beyond the central point.

2. The holding device according to claim 1, wherein the slot forms a movable clamping jaw for clamping the cylindrical blank to a fixed part of the holding device.

3. The holding device according to claim 2, wherein the cylindrical recess comprises a closed bottom surface covering the bottom of the fixed part.

4. The holding device according to claim 2, wherein the bottom surface extends only on one side of the slot.

5. The holding device according to claim 1, wherein the slot runs partially parallel to a lower edge of the holding device.

6. The holding device according to claim 1, wherein the holding device comprises a screw for clamping the blank.

7. The holding device according to claim 1, wherein the holding device comprises a positioning ridge running in the axial direction of the recess.

8. The holding device according to claim 7, wherein the positioning ridge is formed by two grooves running in the axial direction in the cylindrical recess.

9. The holding device according to claim 1, wherein the holding device comprises several cylindrical recesses for inserting blanks.

10. The holding device according to claim 9, wherein the bottom sides of two respective cylindrical recesses are arranged opposite each other.

11. The holding device according to claim 10, wherein the holding device is bar-shaped, block-shaped or rod-shaped.

12. The holding device according to claim 1, wherein the holding device comprises a mechanical interface for fastening or positioning in a ring holder.

13. The holding device according to claim 12, wherein the mechanical interface comprises a bore for receiving a fastening screw.

14. A ring holder for receiving a holding device according to claim 1.

15. A method of producing an abutment, comprising the steps of:
inserting a blank into a holding device according to claim 1; and
producing the abutment without prior calibration of the blank or the interface arranged on the blank.
